(19) United States
(12) Patent Application Publication
(10) Pub. No.: US 2020/0210210 A1
(43) Pub. Date: Jul. 2, 2020

(54) SYSTEMS AND METHODS FOR ENABLING WIDGET CUSTOMIZATION VIA EXTENSION POINTS

(71) Applicant: ServiceNow, Inc., Santa Clara, CA (US)

(72) Inventors: Padmaprabodh Ambale Srinivasamurthy, Hyderabad (IN); Prabhat Mishra, Pratapgarh (IN); Ganapathi Subramanian Balasubramanian, Hydrabad (IN)

(21) Appl. No.: 16/232,762

(22) Filed: Dec. 26, 2018

(51) Int. Cl. G06F 9/451; G06F 8/38; G06F 8/65; G06F 9/448

(52) U.S. Cl. CPC G06F 9/451; G06F 9/4484; G06F 8/65; G06F 8/38

(57) ABSTRACT

The present approach relates to updating a customer-extended application in such a manner that customer extensions of certain widgets in the application are preserved thorough the update. A cloud-computing system may facilitate customer extension of a widget of an initial version of the application by providing a first subset of script associated with one or more extension point hooks, such that the first subset of the script may receive customer script to extend the widget. In this manner, customers may extend aspects of the widget by modifying the script via the one or more extension point hooks to cater those extensible widgets to specific customer needs in a manner that can be maintained as updates occur over time, which may allow the customer to save time and resources that would otherwise be consumed by modifying the application after the enterprise upgrades the application.

### BACKGROUND

The present disclosure relates generally to systems and methods for enabling widget extension via extension point hooks.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Enterprises and other organizations may develop various applications that are licensed or sold to other entities and which may be implemented on various types of computational hardware, network infrastructures, or computational instances. The implementation of the applications to perform a given operation may be realized via the implementation of script (e.g., computer code or logic). In some contexts, the script configured to run on a given client environment instance may be extensible, such that an initial version of an application provided or sold to the entity using the application may be extended to include additional or alternative sets of instructions specific to that entity, such as instructions for accommodating entity-specific functions and widgets into an initial version of the application. In this manner, an entity may extend aspects of the initial version of the application (e.g., the “out-of-the-box” version) to specifically cater to diverse and/or specific needs of the entity. For example, a given application script may be modified to include specific branding or interface themes, selectable widgets, and the like, altering the initial version of the application to meet the needs or purposes of the organization or entity using the application.

However, extending the initial version of the application to cater to these entity preferences, by modifying the associated script, alters the application in a way unique that is unique to the client. In some contexts these customer extensions to the initial version of the application may be overridden and undone at a later time, for example, after performing an enterprise-prompted update to the initial version of the application. When the enterprise-prompted update is applied, the enterprise may prompt the entity to update the application from the initial version of the application to an updated version of the application to improve functionality, remedy previous issues in the script, and so forth. As a result, the script associated with the initial version of the application and its various widgets may be modified in response to the update, such that the extension of the customer may be overridden or erased in response to the update, resulting in a loss of productivity, time, and resources, as the entity may have to remodify the updated script (of the updated version of the application) to include the previously incorporated modifications to the initial version of the application. In addition or alternatively, the enterprise-prompted update may be ignored (i.e., not be applied) in order to preserve customer extensions, resulting in the entity not having access to the latest version of an application and the most recent functionality. As a result, regardless of whether the update is applied or whether the update is ignored, choosing between apply or ignoring the enterprise-wide update may be inconvenient and inefficient. Accordingly, there is a need to improve the manner in which applications are extended and updated.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present approach relates to updating an initial version of an application in such a manner that customer extension of certain widgets in the initial version of the application are preserved thorough the update. Using embodiments disclosed herein, a cloud-computing system may facilitate customer extension of a widget of an initial version of the application by providing a first subset of script associated with an extension point hook, such that the first subset of script may receive customer script to extend the widget. In this manner, customers may extend aspects of the widget by modifying script via the extension point hooks to cater those extensible widgets to specific customer needs in a manner that can be maintained as updates occur over time. Indeed, using the embodiments disclosed herein, the cloud-computing system may receive the customer extensions, such as modifications to script (e.g., computer code or logic) via the extension point hooks, to extend the widget. An enterprise who licenses usage of the initial version of the application to the customers may push server-wide updates to the initial version of the application, such that the customer extensions made via the extension point hooks to certain widgets are preserved through the update, allowing the customer to retain customization through the update, while enabling the customer to save time and resources that would otherwise be consumed by re-extending the application after the enterprise upgrades the application.

### BRIEF DESCRIPTION OF THE DRAWINGS

Various aspects of this disclosure may be better understood upon reading the following detailed description and upon reference to the drawings in which:

FIG. 1 is a block diagram of an embodiment of a cloud-computing system in which embodiments of the present disclosure may operate;

FIG. 2 is a schematic diagram of an embodiment of a multi-instance cloud architecture in which embodiments of the present disclosure may operate;

FIG. 3 is a block diagram of an embodiment of a computing device utilized in a computing system that may be present in FIG. 1 or 2, in accordance with aspects of the present disclosure;

FIG. 4 is a flow diagram of a process for updating an initial version of an application in such a manner that customer extensions of certain widgets in the initial version of the application are preserved thorough the update, in accordance with aspects of the present disclosure;

FIG. 5 is a screenshot of the initial version of the application of FIG. 4, including a widget with a corresponding visual indication, in accordance with aspects of the present disclosure; and

FIG. 6 is a screenshot of a scripting interface, having extension point hooks useful in extending the widget of FIG. 5 via extension point hooks, in accordance with aspects of the present disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” may refer to client-server electronic computing system accessible via various electronic devices, such as, but not limited to, a single computer, virtual machine, virtual container, host, server, laptop, and/or mobile device, or to a plurality of electronic computing devices working together to perform the function described as being performed on or by the computing system. In some embodiments, the computing system may be realized via any suitable circuitry, such as a processor-based device, memory devices, storage devices, and the like. As used herein, the term “medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

As used herein, the term “widget” refers to a user interface element of a graphical user interface (GUI) that operate as a small, self-contained application or applet within the GUI. As such, a widget may be associated with instructions that are executed by a processor-based device to present data (e.g., a graph, plot, etc.) to the user, and to update the data (e.g., summary or graphic data) based on changes to the underlying data. Additionally, certain widgets can be configured by users to provide extended functionality that can be saved for later access and/or transferred to other users. In some contexts, the selection of the widget may present a scripting interface that includes a rectangular area with inextensible (e.g., out-of-the-box (OOTB)) content and empty boxes, such that the empty boxes represent the extension point hooks. Customers may fill these empty boxes (e.g., extension point hooks) within the overall rectangular widget with their extended script (e.g., computer code or logic) to extend the overall widget functionality. In some contexts, the extension point hooks may be easily identified by customers, for example, because the extension point hooks are labelled differently (e.g., with a different color, font size or style, etc.) than the content that may not be extended.

Furthermore, as used herein, an “initial version” of an application may refer to a version of an application (e.g., software modules, software objects, software instances and/or other types of executable code) distributed by a developer, such as an enterprise, a software or application developer, and the like, as part of a sale, licensing arrangement, or other distribution scheme. In some contexts, an initial version of an application as used herein may refer to an OOTB version of the application, which corresponds to an initial, prior, or original version of the application as, for example, as distributed for sale or licensing by one or more clients or customers. Additionally or alternatively, the initial version of an application may correspond to versions of the application unextended, unmodified, or uncustomized by the customer. In other contexts, the initial version of the application may refer to the last functioning version of the application, which in some instances, may correspond to the earlier version of the application or the product release version of the application. In certain instances, the initial version of the applications may be extensible by a purchasing or licensing entity to accommodate client-specific constraints and/or enhance performing client-specific operations. The extended version of the application, as discussed herein, may be referred to as a version of the application that has been extended (e.g., customized, modified, etc.) to include additional functionality or features specific to the customer.

As set forth above, extension of the initial version of the application may be realized via selection of a visual indication on the widget. As used herein, “visual indication” may refer to a portion of the widget that when selected causes a scripting interface to be presented. The scripting interface may include the extension point hooks. “Extension point hooks” refer to an area within the scripting interface where additional content (e.g., script) may be added by a customer via an extension. Such an extension involves adding Hypertext Markup Language (HTML) script, Cascading Style Script (CSS), and/or any other suitable script code or logic. Visual indications on the GUI may be associated to and/or presented on a corresponding widget to indicate that the corresponding widget is extensible, for example, in such a manner that the corresponding widget is able to receive client modifications that may be preserved through an enterprise-wide update.

Along similar lines, the scripting interface associated with the corresponding widget may open in response to selection of the visual indication of the widget. The scripting interface may include script associated with the corresponding widget. The scripting interface may also include extension point hooks that may receive script modification to modify the corresponding widget, accommodating client-specific constraints and/or enhancing the performance of client-specific operations. The scripting interface may also include portions of the script that do not include the extension point hooks, and are therefore inextensible script. After the initial version of the application has been extended based on customer preferences, the application is herein referred to as an “extended version of the application.” Additionally, “updated version of the application” as used herein, refers to a version of an application updated, for example, in response to an enterprise-wide software update.

With this in mind, enterprises and other organizations may develop various applications licensed or sold to other entities and which may be implemented on various types of computational platforms. The implementation of the applications to perform a given operation may be realized via the implementation of script. In some contexts, the script configured to run on a given platform or client instance may be extensible, such that an initial version of an application provided or sold to the entity may be extended to include additional or alternative sets of instructions specific to that entity, such as instructions for addressing issues or contexts specific to that entity. In this manner, an entity may extend aspects of the initial version of the application (e.g., the “out-of-the-box” version) to specifically cater to diverse and/or specific needs of the entity. For example, a given application script may be modified to include specific branding or interface themes, selectable widgets, and the like, altering the initial version of the application to meet the needs or purposes of the organization or entity using the application.

However, extending the initial version of the application to cater to these entity preferences, may alter the application in such a manner than the customer extensions may be overridden and undone at a later time, for example, after performing an enterprise-prompted update to the initial version of the application. Typically, the enterprise may prompt the entity to update the application from the initial version of the application to an updated version of the application to improve functionality, remedy previous issues in the script, and the like. As a result, the script associated with the initial version of the application and its various widgets may be modified in response to the update, such that the extension of the entity may be overridden or erased in response to the update, resulting in a loss of productivity, time, and resources, as the entity may have to remodify the script to include its previously incorporated modifications to the application. In addition or alternatively, the enterprise-prompted update may be ignored (i.e., not be applied) in order to preserve customer customizations, resulting in the customer not having access to the latest version of an application and the most recent functionality. As a result, regardless of whether the update is applied or whether the update is ignored, choosing between apply or ignoring the enterprise-wide update may be inconvenient and inefficient. Accordingly, there is a need to improve the manner in which applications are customized and/or updated, such that entity extension of the widgets or features with respect to the initial version of the application are preserved through subsequent changes (e.g., periodic software updates), the implementation of which may be difficult to employ in practice.

The present approach relates to updating an initial version of an application in such a manner that customer extension of certain widgets in the initial version of the application are preserved thorough the update. Using embodiments disclosed herein, a cloud-computing system may facilitate customer extension of a widget of an initial version of the application by providing a first subset of script associated with an extension point hook, such that the first subset of script may receive customer script to extend the widget. In this manner, customers may extend aspects of the widget by modifying script via the extension point hooks to cater those extensible widgets to specific customer needs in a manner that can be maintained as updates occur over time. Furthermore, using the embodiments disclosed herein, the cloud-computing system may receive the customer extensions, such as modifications to script (e.g., computer code), via extension point hooks, to extend the functionality of widgets. Additionally, script without extension point hooks may be inextensible to the client. The script may be presented via a scripting interface. The cloud-computing system may include one or more extension point, each extension point hook may be associated with a specific scripting language (e.g., HTML, CSS, etc.). In this manner, an enterprise who licenses usage of the initial version of the application to the customers may upgrade an extended version of the application in such a manner that the customer modifications to the second set of the plurality of widgets (e.g., the widgets having the visual indication) are preserved through the upgrade, allowing the customer to retain extensions through the upgrade and enabling the customer to save time and resources that would otherwise be consumed by modifying the extended version of the application after the enterprise upgrades the application.

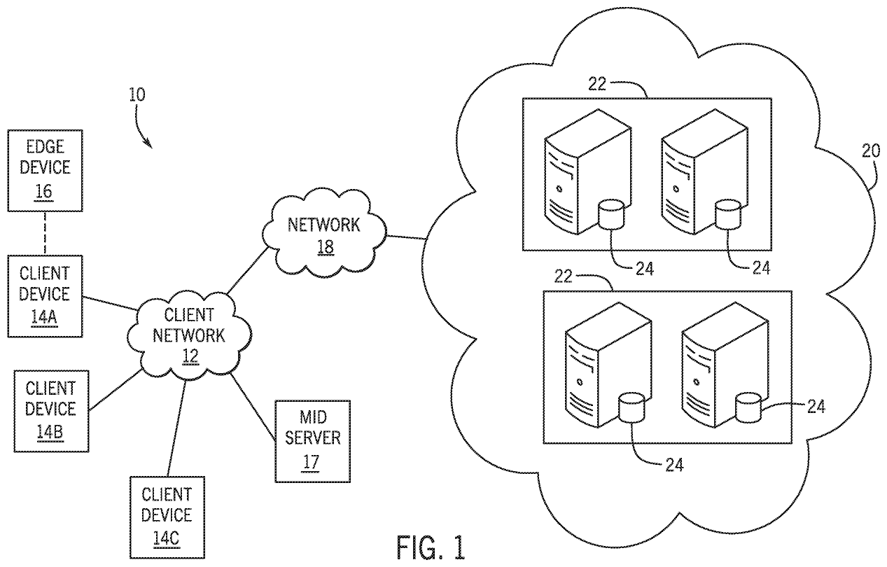

With the preceding in mind, and by way of context, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a block diagram of an embodiment of a cloud-computing system 10, where embodiments of the present disclosure may operate, is illustrated. Cloud-computing system 10 may include a client network 12, network 18 (e.g., the Internet), and a cloud-based platform 20. In some implementations, the cloud-based platform may be a configuration management database (CMDB) platform. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 22, and/or other remote networks. As shown in FIG. 1, the client network 12 is able to connect to one or more client devices 14A, 14B, and 14C so that the client devices are able to communicate with each other and/or with the network hosting the platform 20. The client devices 14A-C may be cloud-computing systems and/or other types of computing devices generally referred to as Internet of Things (IoT) devices that access cloud computing services, for example, via a web browser application or via an edge device 16 that may act as a gateway between the client devices and the platform 20. FIG. 1 also illustrates that the client network 12 includes a bridge device or server, such as a management, instrumentation, and discovery (MID) server 17 that facilitates communication of data between the network hosting the platform 20, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to a network 18. The network 18 may include one or more computing networks, such as other LANs, wide area networks (WAN), the Internet, and/or other remote networks, to transfer data between the client devices 14A-C and the network hosting the platform 20. Each of the computing networks within network 18 may contain wired and/or wireless programmable devices that operate in the electrical and/or optical domain. For example, network 18 may include wireless networks, such as cellular networks (e.g., Global System for Mobile Communications (GSM) based cellular network), IEEE 802.11 networks, and/or other suitable radio-based networks. The network 18 may also employ any number of network communication protocols, such as Transmission Control Protocol (TCP) and Internet Protocol (IP). Although not explicitly shown in FIG. 1, network 18 may include a variety of network devices, such as servers, routers, network switches, and/or other network hardware devices configured to transport data over the network 18.

In FIG. 1, the network hosting the platform 20 may be a remote network (e.g., a cloud network) that is able to communicate with the client devices 14A-C via the client network 12 and network 18. The network hosting the platform 20 provides additional computing resources to the client devices 14A-C and/or client network 12. For example, by utilizing the network hosting the platform 20, users of client devices 14A-C are able to build and execute applications for various enterprise, IT, and/or other organization-related functions. In one embodiment, the network hosting the platform 20 is implemented on one or more data centers 22, where each data center could correspond to a different geographic location. Each of the data centers 22 includes a plurality of virtual servers 24 (which may be referenced herein as application nodes, application servers, virtual server instances, application instances, or application server instances), where each virtual server can be implemented on a physical computing system, such as a single electronic computing device (e.g., a single physical hardware server) or across multiple-computing devices (e.g., multiple physical hardware servers). Examples of virtual servers 24 include, but are not limited to a web server (e.g., a unitary web server installation), an application server (e.g., unitary JAVA Virtual Machine), and/or a database server, e.g., a unitary relational database management system (RDBMS) catalog.

To utilize computing resources within the platform 20, network operators may choose to configure the data centers 22 using a variety of computing infrastructures. In one embodiment, one or more of the data centers 22 are configured using a multi-tenant cloud architecture, such that one of the server instances 24 handles requests from and serves multiple customers. Data centers with multi-tenant cloud architecture commingle and store data from multiple customers, where multiple customer instances are assigned to one of the virtual servers 24. In a multi-tenant cloud architecture, the particular virtual server 24 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from certain drawbacks, such as a failure of a particular one of the server instances 24 causing outages for all customers allocated to the particular server instance.

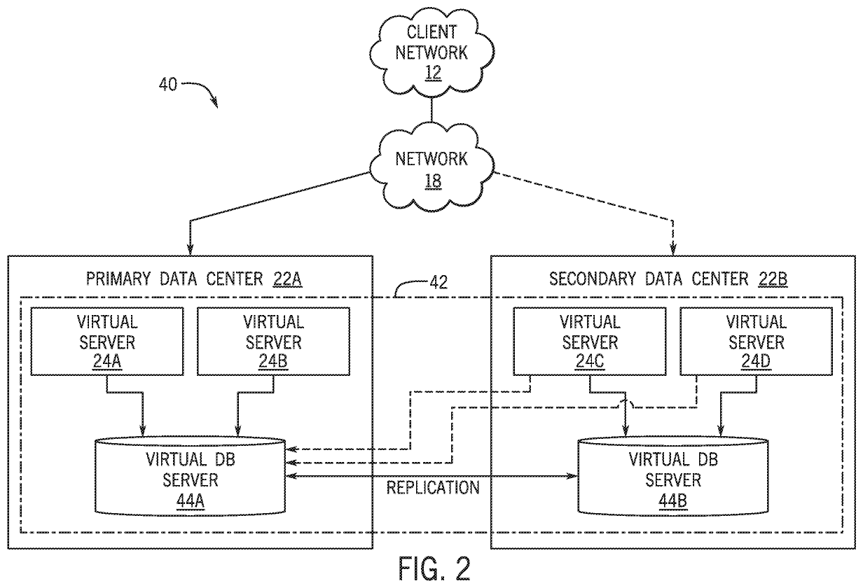

In another embodiment, one or more of the data centers 22 are configured using a multi-instance cloud architecture to provide every customer its own unique customer instance or instances. For example, a multi-instance cloud architecture could provide each customer instance with its own dedicated application server(s) and dedicated database server(s). In other examples, the multi-instance cloud architecture could deploy a single physical or virtual server and/or other combinations of physical and/or virtual servers 24, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 20, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 40 where embodiments of the present disclosure may operate. FIG. 2 illustrates that the multi-instance cloud architecture 40 includes the client network 12 and the network 18 that connect to two (e.g., paired) data centers 22A and 22B that may be geographically separated from one another. Using FIG. 2 as an example, network environment and service provider cloud infrastructure client instance 42 (also referred to herein as a client instance 42) is associated with (e.g., supported and enabled by) dedicated virtual servers (e.g., virtual servers 24A, 24B, 24C, and 24D) and dedicated database servers (e.g., virtual database servers 44A and 44B). Stated another way, the virtual servers 24A-24D and virtual database servers 44A and 44B are not shared with other client instances and are specific to the respective client instance 42. In the depicted example, to facilitate availability of the client instance 42, the virtual servers 24A-24D and virtual database servers 44A and 44B are allocated to two different data centers 22A and 22B so that one of the data centers 22 acts as a backup data center. Other embodiments of the multi-instance cloud architecture 40 could include other types of dedicated virtual servers, such as a web server. For example, the client instance 42 could be associated with (e.g., supported and enabled by) the dedicated virtual servers 24A-24D, dedicated virtual database servers 44A and 44B, and additional dedicated virtual web servers (not shown in FIG. 2).

Although FIGS. 1 and 2 illustrate specific embodiments of a cloud-computing system 10 and a multi-instance cloud architecture 40, respectively, the disclosure is not limited to the specific embodiments illustrated in FIGS. 1 and 2. For instance, although FIG. 1 illustrates that the platform 20 is implemented using data centers, other embodiments of the platform 20 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For example, using FIG. 2 as an example, the virtual servers 24A-D and virtual database servers 44A and 44B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

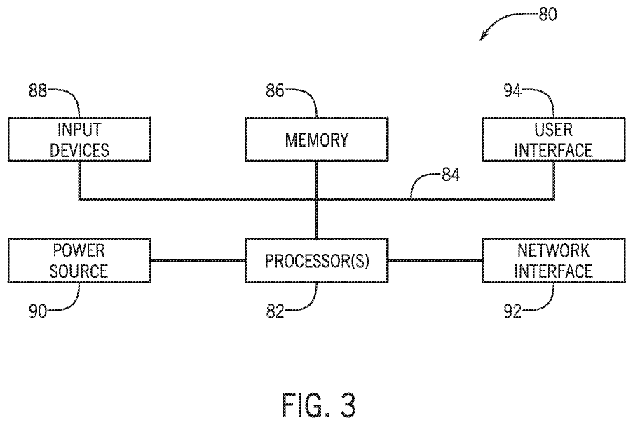

With this in mind, and by way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3 and may be present in the embodiments of FIGS. 1 and 2. FIG. 3 generally illustrates a block diagram of example components of a computing system 80 and their potential interconnections or communication paths, such as along one or more busses 84. As illustrated, the computing system 80 may include various hardware components such as, but not limited to, one or more processors 82, one or more busses 84, memory 86, input devices 88, a power source 90, a network interface 92, a user interface 94, and/or other computer components useful in performing the functions described herein. The one or more processors 82 may include one or more microprocessors capable of performing instructions stored in the memory 86. Additionally or alternatively, the one or more processors 82 may include application-specific integrated circuits (ASICs), field-programmable gate arrays (FPGAs), and/or other devices designed to perform some or all of the functions discussed herein without calling instructions from the memory 86.

With respect to other components, the one or more busses 84 includes suitable electrical channels to provide data and/or power between the various components of the computing system 80. The memory 86 may include any tangible, non-transitory, and computer-readable storage media. Although shown as a single block in FIG. 1, the memory 86 can be implemented using multiple physical units of the same or different types in one or more physical locations. The input devices 88 correspond to structures to input data and/or commands to the one or more processor 82. For example, the input devices 88 may include a mouse, touchpad, touchscreen, keyboard and the like. The power source 90 can be any suitable source for power of the various components of the computing system 80, such as line power and/or a battery source. The network interface 92 includes one or more transceivers capable of communicating with other devices over one or more networks (e.g., a communication channel). The network interface 92 may provide a wired network interface or a wireless network interface. A user interface 94 may include a display that is configured to display text or images transferred to it from the one or more processors 82. In addition and/or alternative to the display, the user interface 94 may include other devices for interfacing with a user, such as lights (e.g., LEDs), speakers, and the like.

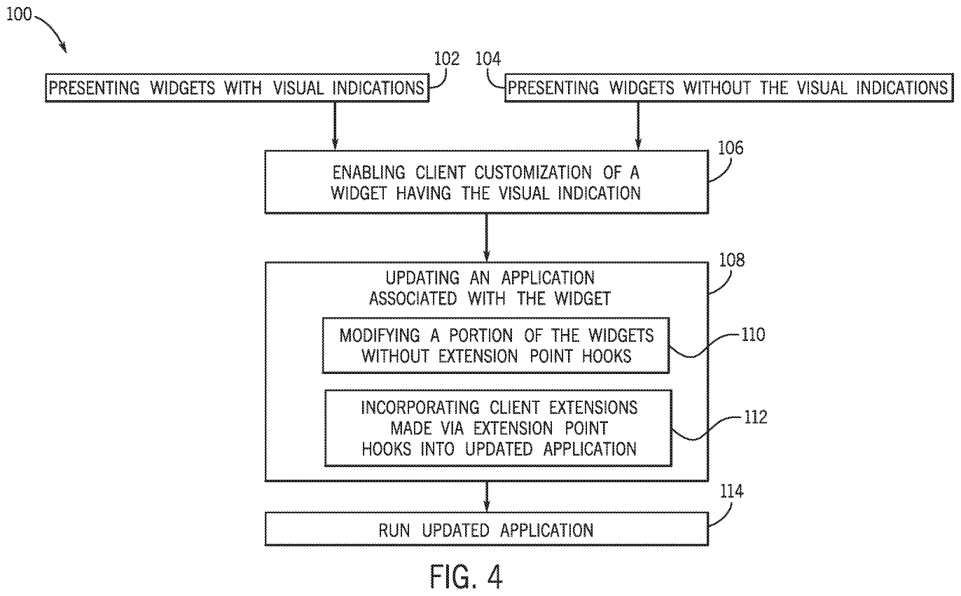

With the preceding in mind, FIG. 4 is a flow diagram 100 of a process for updating an initial or extended version of an application in such a manner that customer extensions of certain widgets is preserved through an update, in accordance with aspects of the present disclosure. The steps illustrated in the flow diagram 100 may be performed by the cloud-computing system 10 for the purposes of presenting selectable visual indications on a graphical user interface (GUI) running the initial version of the application, allowing customers to extend certain widgets running on the initial version of the application by selecting the visual indication of the graphical user interface, and loading a scripting interface in response to selecting the visual indication. By allowing client modification via extension point hooks of those widgets associated with the visual indication, the cloud-computing system 10 may enable enterprise-wide updates to be applied while retaining customer extensions (e.g., made via the extension point hooks) of those widgets associated with the visual indications. Furthermore, the steps illustrated in the flow diagram 100 are meant to facilitate discussion and are not intended to limit the scope of this disclosure, since additional steps may be performed, certain steps may be omitted, and the illustrated steps may be performed in alternative orders.

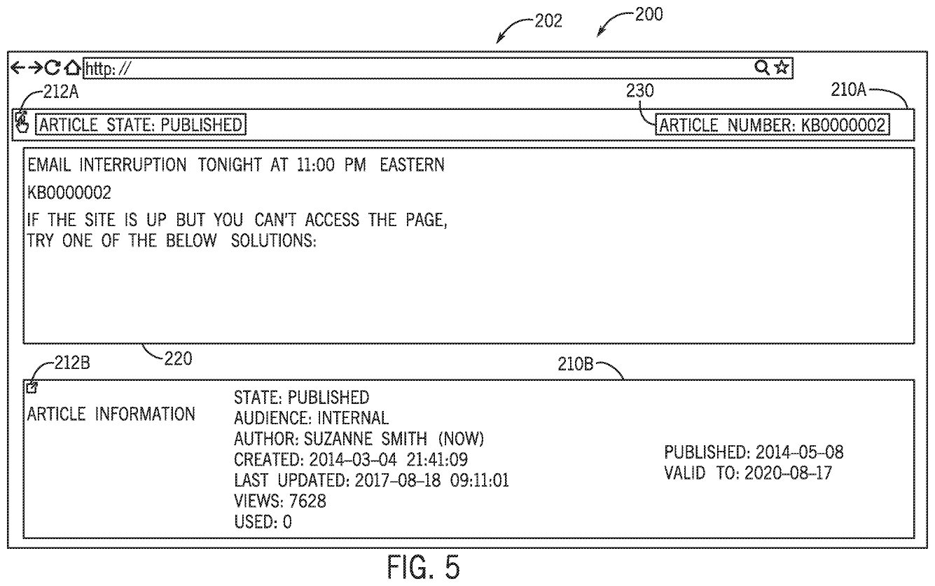

The flow diagram 100 may include presenting (process block 102) a first set of widgets (i.e., those widgets with the visual indications) and/or presenting (process block 104) a second set of widgets (i.e., those widgets without the visual indications), in response to running an initial version of an application. The client instance 42 may present (process blocks 102, 104) the widgets with and/or the widgets without the visual indications on the GUI accessible to a client, as illustrated and described below with regard to FIG. 5. The visual indications may indicate that the corresponding widget is extensible, such that client extension of the corresponding widget via the extension point hooks may be preserved through an update (e.g., an enterprise-wide software update).

In this manner, the cloud-computing system 10 may enable (process block 106) client extension of the script (e.g., via extension point hooks) associated with a widget having the visual indication and prevent client extension of the script associated with a widget not having the visual indication. As discussed in detail below, with regard to FIG. 5, the selection of the visual indication may cause presentation of a scripting interface with extension point hooks. In some contexts, the scripting interface that may receive customer inputs indicative of client modifications (e.g., extensions) to the corresponding widget (e.g., in the form of suitable script) via the extension point hooks. In one embodiment, the scripting interface may provide empty text boxes that serve as extension point hooks that may receive client-preferred script for modifying functionality of the widget. While this example is discussed in the context of modifying a widget on an initial version of an application by modifying script, it should be understood that any suitable technique for extending an application may be employed with the embodiments disclosed herein.

Furthermore, one or more devices of the cloud-computing system 10 may update (process block 108) the extended or initial version of the application and the widgets associated with that version of the application, for example, in accordance with an enterprise-wide software update pushed to all client instances. By employing the embodiments disclosed herein, updating the extended or initial version of the application may upgrade the widgets associated with the extended or initial version of the application while preserving the client extensions to a widget made via the extension point hooks. In one embodiment, updating (process block 108) the initial version of the application may include modifying (process block 110) a portion of the scripting interface without extension point hooks to include aspects of the update while incorporating (process block 112) the client extensions made via extension point hooks onto the updated application. In one implementation, modifying (process block 110) the portion of the scripting interface without extension point hooks may include replacing the script without extension point hooks with the new script associated with the update. In another implementation, updating the extended or initial version of the application may include portions of the script that have not received customer extensions, regardless of whether the script include extension point hooks or not.

Incorporating (process block 112) onto the updated application the client extensions made via the extension point hooks may include leaving the script associated with the extension point hooks unaltered by the update, such that the client extensions to the widget are preserved through the update. Alternatively, incorporating process block 112) the client extensions of the script with extension point hooks onto the upgraded application may include modifying the script with extension point hooks that have been extended by the client and not modifying the script with extension point hooks that have not been extended by the client. In this manner, the client extensions are preserved through the update, while updating as much of the application that has not been extended by the client.

After the initial version of the application has been updated, a client instance running on the cloud-computing system 10 may run the updated version of the application. The updated version of the application may apply the update while maintaining the customer extensions made via the extension point hooks.

To help illustrate, FIG. 5 is a screenshot 200 of the initial version of the application 202 of FIG. 4, including a widget 210 with a corresponding visual indication 212, in accordance with aspects of the present disclosure. In this example, the initial version of the application 202 includes a first widget 210A with a corresponding visual indication 212A and a second widget 210B with a corresponding visual indication 212B. The initial version of the application 202 also includes a third widget 220 without the visual indication 212. A client device 14 may present (process block 102, 104; FIG. 4) the widgets 210 with the visual indication 212 and the widgets 220 without the visual indication 212, for example, via a GUI accessible to a customer.

As discussed above, the visual indication 212 may serve as a visual indication, conveying to the customer that the corresponding widget 210 may be extended by a customer in such a manner that the extension is preserved through an update, such as an enterprise-wide software update. Furthermore, a customer may customize those widgets 210 with the visual indication 212 by selecting the visual indication 212. For example, a customer may select the first visual indication 212A to customize the article number 230 associated with the first widget 210A or the customer may select the second visual indication 212B to customize the article information (including, in the this example, the state, audience, author, date created, and so forth) associated with the second widget 210B. For purposes of this discussion, after the customer extends functionality of a widget 210 having a visual indication 212, the initial version of the application 202 becomes an extended version of the application.

While the illustrated example includes three widgets, it should be understood that provision of such example is meant to facilitate discussion and is not intended to limit the scope of the disclosure. For example, in some contexts, an application may include any number of widgets with any suitable selectable visual indication that may convey to a customer that the corresponding script may be extended by the customer in such a manner that the extension is preserved through an update.

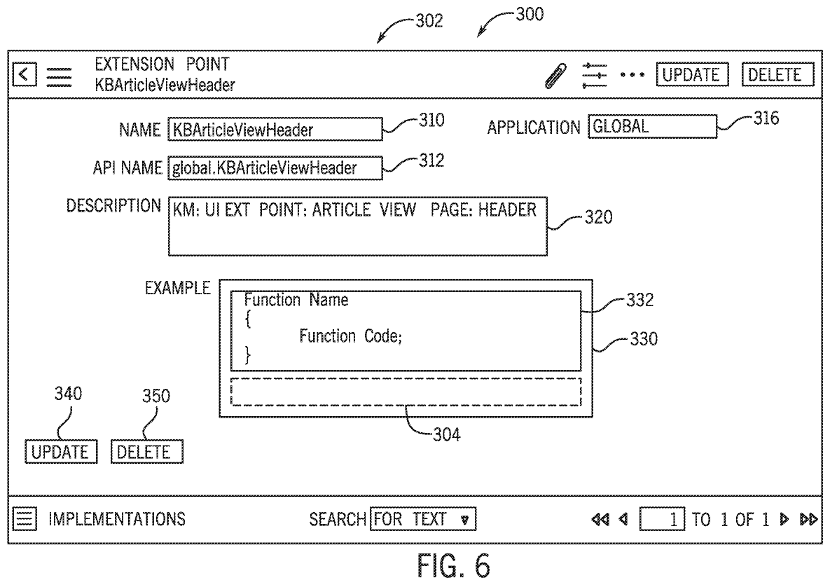

In response to selection of the visual indication 212, the cloud-computing system may cause the client device 14 to present a scripting interface that may allow a customer to modify existing script, add existing script, or delete existing script associated with the widget via extension point hooks. To that end, FIG. 6 is a screenshot 300 of a scripting interface 302 useful in extending or modifying the widgets of FIG. 5 via extension point hooks 304, in accordance with aspects of the present disclosure.

In this example, the scripting interface 302 may include respective text boxes (or scroll down menus) for specifying a widget name 310 (in this example “KBArticleViewHeader”), an API name 312, an application type 316, and a brief description 320. Furthermore, the scripting interface 302 may include a scripting window 330 for extending (e.g., modifying), adding, deleting, and so forth, script associated with the widget 210 via the extension point hooks 304. The scripting window 330 may include extension point hooks 304 that may receive customer extended script, such that the script received via the extension point hooks 304 is preserved through an update. As illustrated, the extension point hook 304 may include a blank text box that may receive suitable script (e.g., HTML, CSS, etc.). In some contexts, the extension point hooks 304 may be associated with existing script, such that the existing script associated with the extension point hooks 304 may be extended based on customer extensions made via the extension point hook 304. Further, the scripting interface may include any number of (e.g., one or more) extension point hooks 304. As illustrated, the scripting window 330 may also include inextensible script 332. In some contexts, the extension point hooks 304 may be separated from the inextensible script 332, such that the extension point hooks 304 and the inextensible script 332 are contained in respective text boxes.

The scripting interface 302 may also include a first selectable feature 340 for updating and saving changes made to the script via the extension point hooks 304, such that the saved changes are pushed into the widget 210 when the application containing the widget is run. Additionally, the scripting interface 302 may include a second selectable feature 350 for deleting the selected script. While only a few features of the scripting interface are discussed with respect to FIG. 6, it should be understood that any suitable method or techniques for updating the widget may be employed in addition to or alternative to the scripting interface 302.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A system, comprising:
a client instance hosted by a platform, wherein the client instance is accessible by one or more remote client networks, and wherein the system is configured to perform acts comprising:
presenting a plurality of widgets in response to running an application on the client instance, wherein each widget of a first subset of the plurality of widgets is displayed with a corresponding visual indication that the first subset of the plurality of widgets are extensible;
allowing a client extension to a first subset of a script of a selected widget of the first subset of the plurality of widgets in response to selection of the corresponding visual indication corresponding to the selected widget, wherein the first subset of the script comprises one or more extension point hooks;
determining whether the application received the client extension to the first subset of the script of the selected widget; and
updating the application in accordance with an update, wherein updating the application comprises modifying a second subset of the script, and wherein updating the application comprises preserving the client extension to the first subset of the script in response to determining the application received the client extension.

2. The system of claim 1, wherein the one or more extension point hooks are omitted from the second subset of the script.

3. The system of claim 1, wherein the client extension is present on the updated application.

4. The system of claim 1, wherein the act of updating the application comprises replacing the first subset of the script in accordance with the update when the first subset of the script does not receive the client extension via the one or more extension point hooks.

5. The system of claim 1, wherein the first subset of the script is exempt from the update, wherein the first subset of the script is unchanged by the update, and wherein the first subset of the script is identical as present in the application and the updated application.

6. The system of claim 1, wherein the plurality of widgets comprises a second subset of the plurality of widgets, wherein each widget of the second subset of the plurality of widgets is displayed without the corresponding visual indication.

7. The system of claim 1, wherein selection of the corresponding visual indication causes the system to:
open a scripting interface;
present the script of the selected widget; and
enable a client to modify the script of the selected widget.

8. The system of claim 7, wherein the script associated with the selected widget comprises Hypertext Markup Language (HTML) script, Cascading Style Script (CSS), or any combination thereof.

9. The system of claim 1, wherein the corresponding visual indication comprises a selectable feature present or displayed on a corresponding widget of the first subset of the plurality of widgets presented on a graphical user interface (GUI) accessible to a client.

10. A processor-implemented method to update an application, the method comprising:
presenting a plurality of widgets in response to running the application on a client instance accessible via a client device, wherein each widget of a first subset of the plurality of widgets is displayed with a corresponding visual indication that the first subset of the plurality of widgets are extensible;
enabling a client extension to a first subset of a script of a selected widget of the first subset of the plurality of widgets in response to selection of the corresponding visual indication corresponding to the selected widget, wherein the first subset of the script comprises one or more extension point hooks;
determining whether the application received the client extension to the first subset of the script of the selected widget; and
updating the application in accordance with an update, wherein updating the application comprises modifying a second subset of the script associated with a second subset of the plurality of widgets different from the first subset of the plurality of widgets, and wherein updating the application comprises preserving the client extension to the first subset of the script in response to determining the application received the client extension.

11. The processor-implemented method of claim 10, wherein the one or more extension point hooks is omitted from the second subset of the script.

12. The processor-implemented method of claim 10, wherein the client extension is present on the updated application.

13. The processor-implemented method of claim 10, wherein updating the application comprises replacing the first subset of the script in accordance with the update when the first subset of the script does not receive the client extension via the one or more extension point hooks.

14. The processor-implemented method of claim 10, wherein the updating the application exempts the first subset of the script from the update, wherein the first subset of the script is unchanged by the update and is identical as present in the application and the updated application.

15. The processor-implemented method of claim 10, wherein the selection of the corresponding visual indication comprises:
opening a scripting interface;
presenting the script of the selected widget; and
enabling a client to modify the script of the selected widget.

16. A tangible, non-transitory, machine-readable medium, comprising machine-readable instructions, wherein the machine-readable instructions, when executed by one or more processors, cause the one or more processors to:
present a plurality of widgets in response to running an application on a client instance accessible via a client device, wherein each widget of a first subset of the plurality of widgets is displayed with a corresponding visual indication that the first subset of the plurality of widgets are extensible; and
allow a client extension to a first subset of a script of a selected widget of the first subset of the plurality of widgets in response to selection of the corresponding visual indication corresponding to the selected widget, wherein the first subset of the script comprises one or more extension point hooks;
determine whether the application received the client extension to the first subset of the script of the selected widget; and
update the application in accordance with an enterprise-wide update, wherein updating the application comprises modifying a second subset of the script, and wherein updating the application comprises preserving the client extension to the first subset of the script in response to determining the application received the client extension.

17. The tangible, non-transitory, machine-readable medium of claim 16, wherein the one or more extension point hooks comprise a blank text box configured to receive the client extension.

18. The tangible, non-transitory, machine-readable medium of claim 17, wherein the machine-readable instructions that cause the one or more processors to update the application comprise causing the one or more processors to preserve the client extension through the enterprise-wide update, wherein the client extension is present on the updated application.

19. The tangible, non-transitory, machine-readable medium of claim 17, wherein the machine-readable instructions that cause the one or more processors to update the application comprise causing the one or more processors to update the first subset of the script that has not received the client extension and updating the second subset of the script in accordance with the enterprise-wide update.

20. The tangible, non-transitory, machine-readable medium of claim 17, wherein the first subset the script is exempt from the enterprise-wide update, wherein the first subset of the script is unchanged by the enterprise-wide update, and wherein the first subset the script is identical as present in the application and the updated application.
